(19) United States
(12) Patent Application Publication
(10) Pub. No.: US 2007/0023398 A1
(43) Pub. Date: Feb. 1, 2007

(54) Plasma processing apparatus

(75) Inventors: Hiroyuki Kobayashi, Kodaira (JP); Masatoshi Miyake, Kokubunji (JP); Kenetsu Yokogawa, Tsurugashima (JP); Masaru Izawa, Hino (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/355,165

(22) Filed: Feb. 16, 2006

(30) Foreign Application Priority Data
Jul. 27, 2005 (JP) 2005-217552

(51) Int. Cl. B23H 7/00; B23H 1/00

(52) U.S. Cl. 219/69.12

(57) ABSTRACT

A plasma processing apparatus which can remove foreign particles over an object to be processed during or before/after the discharging is provided. The plasma processing apparatus includes a processing chamber; a processing gas supplying unit for supplying a processing gas into the processing chamber, an antenna electrode for supplying a radio frequency electric power into the processing chamber and forming a plasma, a vacuum evacuating unit for evacuating the inside of the processing chamber; a disposing electrode for disposing the object into the processing chamber and holding the object therein; and a DC power supply for supplying a negative electric potential to the antenna electrode.

### BACKGROUND OF THE INVENTION

1. Field of the Invention

The invention relates to a plasma processing apparatus and, more particularly, to a plasma processing apparatus which can remove foreign particles over an object to be processed (hereinafter, referred to as a processing object).

2. Related Art

In a manufacturing step of a semiconductor device such as DRAM, microprocessor, or the like, a plasma etching apparatus or a plasma CVD apparatus is widely used. As a problem in the working using a semiconductor manufacturing apparatus using a plasma, a decrease in the number of foreign matters which are deposited onto the processing object can be mentioned. For example, if a foreign particle is deposited onto a fine pattern of the processing object during an etching treatment, the etching of such a portion is locally obstructed, so that a defect such as a disconnection or the like occurs in the objects and a manufacturing yield deteriorates.

As a foreign particle control method of preventing foreign particles from being deposited onto a processing object in a plasma processing apparatus, for example, a method of controlling transport of the foreign particles by gas flow control or a method of controlling transport of the charged foreign particles by a Coulomb force (refer to JP-A-5-47712) has been known. Particularly, since the foreign particles are charged in the plasma during the plasma discharging, the method of controlling the transport of the foreign particles by the Coulomb force is useful.

The behavior of the foreign particles in the plasma discharging will now be described. First, when the plasma discharging is started, an electric field in a processing chamber changes suddenly. In association with such a sudden change in the electric field in the processing chamber, the foreign particles deposited onto an inner wall of the processing chamber swirl up. Subsequently, during the plasma discharging, the foreign particles are charged in the plasma and trapped near a plasma sheath which is formed between the object such as processing chamber, processing object, or the like and the plasma. When the plasma discharging is finished, the foreign particles trapped near the plasma sheath are released from the trap caused by the sheath. A part of the released foreign particles are deposited onto the processing object.

Therefore, to prevent the foreign particles from being deposited onto the processing object, it is important to control electric field distribution in the processing chamber at the start and end of the discharging and control the transport of the foreign particles. During the discharging, it is also important that the foreign particles trapped near the sheath are guided to a position away from the processing object by using the Coulomb force, a viscosity force of the gas, or the like.

### SUMMARY OF THE INVENTION

When a structure such as a dust collecting electrode or the like to capture the foreign particles is disposed in the processing chamber in order to control the transport of the foreign particles during the discharging, a sheath is formed at an interface between the plasma and the dust collecting electrode. Since a steep electric potential gradient is formed in the sheath, even if a bias is applied to the dust collecting electrode, mainly, the potential gradient in the sheath merely changes and a potential gradient of the bulk plasma does not largely change.

A thickness of sheath is equal to a value which is about 10 times as large as a Debye length. For example, the thickness of sheath in the typical process plasma (an electron temperature is equal to about 3 eV; an electron density is equal to 10¹¹ cm⁻³) is equal to about 0.1 mm. Therefore, in the case of disposing the dust collecting electrode or the like into the processing chamber and applying the bias to the dust collecting electrode, the foreign particles floating near the dust collecting electrode can be removed by the Coulomb force. However, it is difficult to control the transport of the foreign particles, specifically speaking, to capture the foreign particles floating at a place away from the dust collecting electrode at a distance which is, for example, tens of times or more as large as the thickness of sheath.

On the other hand, a shielding effect of the electric potential by the sheath is weakened at the start or end of the plasma discharging. Therefore, an electric field can be also formed at a position away from the dust collecting electrode. However, for example, in the case of applying a single bias potential to the whole side wall of the processing chamber, it is difficult that an electric field of an intensity enough to control the transport of the foreign particles is formed over the processing object near almost the center of the processing chamber.

The invention is made in consideration of those problems and intends to provide a plasma processing apparatus which can remove foreign particles over a processing object during discharging or before and after the discharging.

To solve the above problems, the invention provides the following construction.

According to one aspect of the invention, a plasma processing apparatus includes: a processing chamber; processing gas supplying means for supplying a processing gas into the processing chamber; an antenna electrode for supplying a radio frequency electric power into the processing chamber and forming a plasma; vacuum pump means for evacuating the inside of the processing chamber; a disposing electrode for disposing a processing object into the processing chamber and holding it therein; and a DC power supply for supplying a negative electric potential to the antenna electrode.

Since the plasma processing apparatus of the invention has the above construction, the foreign particles above the processing object can be removed during the discharging or before and after the discharging.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining a plasma processing apparatus according to the first embodiment of the invention;

FIG. 2 is a diagram for explaining details of a filter unit shown in FIG. 1;

FIG. 3 is a diagram for explaining an effect according to the embodiment;

FIG. 4 is a diagram for explaining a plasma processing apparatus according to the second embodiment of the invention;

FIG. 5 is a plan view of a processing chamber 1;

FIG. 6 is a diagram for explaining an effect according to the embodiment;

FIG. 7 is a diagram for explaining the third embodiment of the invention;

FIGS. 8A to 8D are diagrams for explaining a method of embedding side wall electrodes into a side wall of the processing chamber;

FIG. 9 is a diagram for explaining a method of supplying an electric power to the side wall electrodes;

FIG. 10 is a diagram for explaining another method of supplying an electric power to the side wall electrodes;

FIG. 11 is a diagram for explaining the fourth embodiment of the invention;

FIG. 12 is a diagram for explaining an effect according to the embodiment;

FIG. 13 is a diagram for explaining the fifth embodiment of the invention; and

FIG. 14 is a diagram for explaining a method of controlling electric potential distribution in the processing chamber.

### DESCRIPTION OF THE EMBODIMENTS

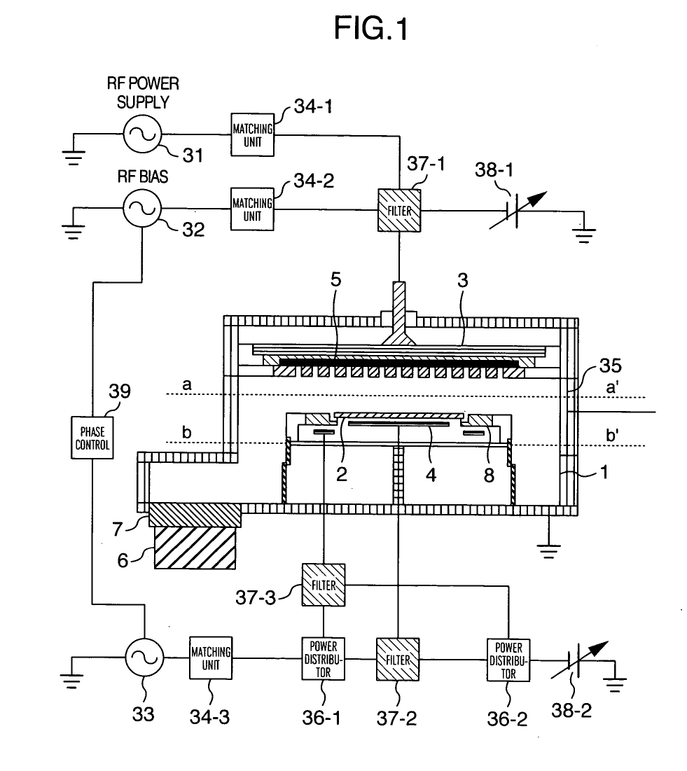

Best embodiments will be described hereinbelow with reference to the drawings. FIG. 1 is a diagram for explaining a plasma processing apparatus (UHF-ECR plasma processing apparatus of a parallel flat type) according to the first embodiment of the invention. As shown in the diagram, a processing chamber 1 is connected to the ground and inner walls of the processing chamber are coated with a film made of yttria, alumite, or the like.

A flat antenna electrode 3 to irradiate electromagnetic waves is arranged in an upper portion of the processing chamber 1. The flat antenna electrode 3 is disposed in parallel with a disposing electrode 4 to dispose a processing object 2 such as a wafer or the like. A shower plate 5 is disposed under the antenna electrode 3. A processing gas is supplied into the processing chamber through a gas hole provided for the shower plate.

Vacuum pump 6 such as a turbo-molecular pump or the like to reduce a pressure in the processing chamber is attached to the processing chamber 1 through a butterfly valve 7. A discharge power supply (RF (radio frequency) power supply) 31 to generate a plasma is connected to the antenna electrode 3 through a matching unit 34-1 and a filter unit 37-1. The plasma is efficiently generated by an electron cyclotron resonance according to an interaction between a radio frequency electric power to form the plasma which is irradiated from the antenna electrode 3 and a magnetic field formed by a coil (not shown) disposed over the processing chamber. By controlling distribution of the magnetic field, transport distribution of the plasma can be controlled.

An RF (radio frequency) bias power supply 32 to apply a bias electric power of a high frequency to the antenna electrode is connected to the antenna electrode 3 through a matching unit 34-2 and the filter unit 37-1 (an effect will be described hereinafter). A DC power supply 38-1 to control an electric potential of the antenna electrode is connected to the antenna electrode 3 through the filter unit 37-1.

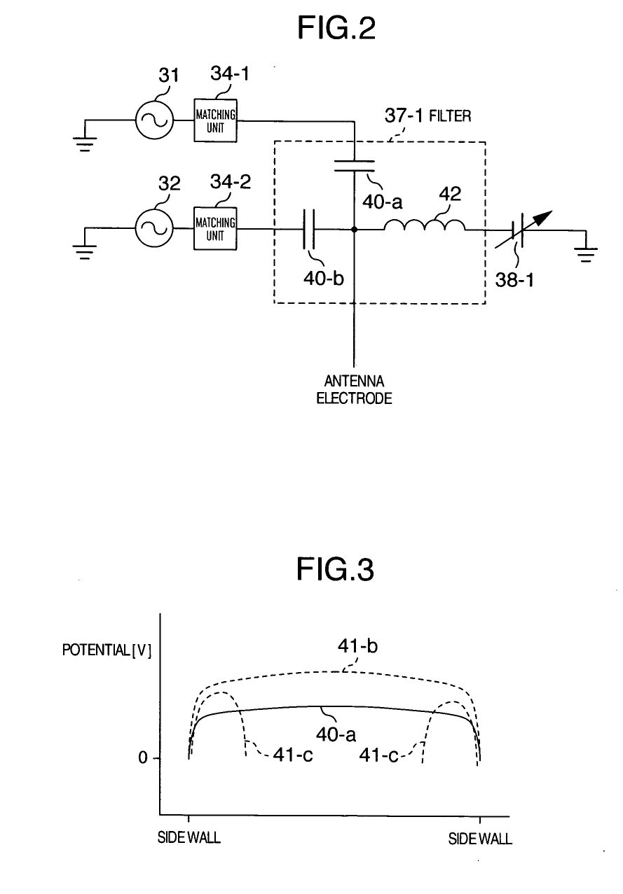

FIG. 2 is a diagram for explaining details of the filter unit 37-1 shown in FIG. 1. As shown in the diagram, an output of the RF power supply 31 to generate the plasma is applied to the antenna electrode through the matching unit 34-1 and a capacitor 40-a of the filter unit 37-1. An output of the RF bias power supply 32 is applied to the antenna electrode through the matching unit 34-2 and a capacitor 40-b of the filter unit 37-1. An output of the DC power supply 38-1 is applied to the antenna electrode through a coil 42 of the filter unit 37-1.

Thus, for example, it is possible to prevent such a situation that the output of the RF power supply to generate the plasma or the output of the RF bias power supply 32 to apply the radio frequency bias to the antenna electrode flows to the DC power supply 38-1 side or the output of the DC power supply 38-1 flows to the RF power supply 31 or the RF bias power supply 32.

An inductance of a coil 42 is determined so that both of the radio frequency electric power of the RF power supply 31 to generate the plasma and the bias electric power of the RF bias power supply 32 to apply the radio frequency bias to the antenna electrode are not transmitted. A capacitance of the capacitor 40-a of the RF power supply 31 side to generate the plasma is selected to a value so that the bias electric power of the RF bias power supply 32 to apply the radio frequency bias to the antenna electrode is not transmitted.

In order to accelerate ions which enter the processing object 2, an RF bias power supply 33 is connected to the processing object disposing electrode 4 through a matching unit 34-3, a power distributor 36-1, and a filter unit 37-2. A radio frequency bias electric power which is outputted from the RF bias power supply 33 is branched into two RF bias electric powers by the power distributor 36-1. One of them is applied to the processing object 2 through the filter unit 37-2 and the other is applied to a focusing ring 8 through a filter unit 37-3. A ratio between the RF bias electric powers which are respectively applied to the focusing ring 8 and the processing object 2 can be controlled by the power distributor 36-1. Thus, radical distribution in the plasma, a fine pattern working inclination near the outer periphery of the processing object, and the like can be controlled.

It is assumed that the RF bias electric power which is applied to the disposing electrode 4 and the RF bias electric power which is applied to the antenna electrode have the same frequency. A difference between phases of the RF bias electric power which is applied to the antenna electrode and the RF bias electric power which is applied to the disposing electrode can be controlled by a phase controller 39. In the case of controlling the phase difference to 180°, plasma confinement is improved and fluxes and energy of ions which enter the side wall of the processing chamber decrease. Thus, a generation amount of foreign matters or particles which are caused by consumption of the side wall decreases. A life of coating layer or the like of a wall material can be prolonged. In the case of controlling the phase difference to 0°, since the plasma is widened in the side wall direction, for example, in the case of using an oxygen plasma, the side wall can be cleaned at a high speed.

A DC power supply 38-2 is connected to the disposing electrode. Thus, the processing object can be electrostatically adsorbed and fixed to the disposing electrode. Electric potentials of the processing object and the focusing ring can be controlled. A DC electric power which is outputted from the DC power supply 38-2 is branched into two DC electric powers by a power distributor 36-2. One of them is applied to the processing object through the filter unit 37-2 and the other is applied to the focusing ring through the filter unit 37-3.

FIG. 3 is a diagram for explaining an effect according to the embodiment and shows space potential distribution between a-a′ and a space electric potential between b-b′ in FIG. 1. It is assumed that the phase difference between the RF bias electric power which is applied to the antenna electrode and the RF bias electric power which is applied to the disposing electrode is equal to 180°.

A broken line 41-b in FIG. 3 indicates potential distribution in a processing space (a-a′) over a wafer serving as a processing object when the DC bias electric power is not applied to the antenna electrode 3. A broken line 41-c indicates space potential distribution in a processing space (b-b′) under the wafer surface. On the other hand, a solid line 41-a indicates potential distribution in the processing space (a-a′) over the wafer when the DC electric potential of the antenna electrode is reduced to, for example, −400V by the DC power supply 38-1.

As will be understood from a comparison between the solid line 41-a and the broken line 41-b, by reducing the electric potential of the antenna electrode 3, the space potential in the processing space over the wafer can be reduced. That is, although the electric field (shape of the potential distribution) almost above the processing object does not change so much, the potential distribution (absolute value) can be largely changed.

On the other hand, the space potential under the wafer surface hardly changes even if the electric potential of the antenna electrode 3 is controlled (almost equal to the space potential 41-c). This is because by setting the phase difference between the RF bias electric power which is applied to the antenna electrode and the RF bias electric power which is applied to the disposing electrode to 180°, the plasma confinement is improved and, further, an electric potential of a bulk plasma between the antenna electrode 3 and the disposing electrode 4 is difficult to be influenced by the electric potential of the side wall of the processing chamber.

Therefore, by reducing the electric potential of the antenna electrode 3, the electric potential in the processing space over the wafer surface can be reduced to a value lower than the electric potential in the processing space under the wafer surface. Foreign particles which have been charged to the negative electric potential can be conveyed from the processing space over the processing object into the space on the evacuating side under the wafer surface. Thus, the foreign particles can be removed from the space over the processing object. If the electric potential of the disposing electrode is reduced by using the DC power supply connected to the disposing electrode, the electric potential of the bulk plasma almost above the processing object can be reduced to a value lower than that in the case of reducing only the electric potential of the antenna electrode. Therefore, a larger removing effect of the foreign particles is obtained.

Further, if the ratio between the DC electric power which is applied to the focusing ring 8 and the DC electric power which is applied to the processing object 2 is adjusted and the electric potential of the processing object is reduced to a value lower than that of the focusing ring, the foreign particles trapped to the sheath over the processing object can be guided in the direction of the side wall. Such transport control of the foreign particles can be also realized by a method whereby the ratio between the RF bias electric powers which is applied to the processing object and the RF bias electric power which is applied to the focusing ring is adjusted and a self bias electric potential of the processing object is set to a value lower than a self bias of the focusing ring. By reducing the electric potential of the processing space over the processing object and further controlling the electric field near the sheath as mentioned above, the foreign particles can be efficiently guided to the evacuating side from the space over the processing object.

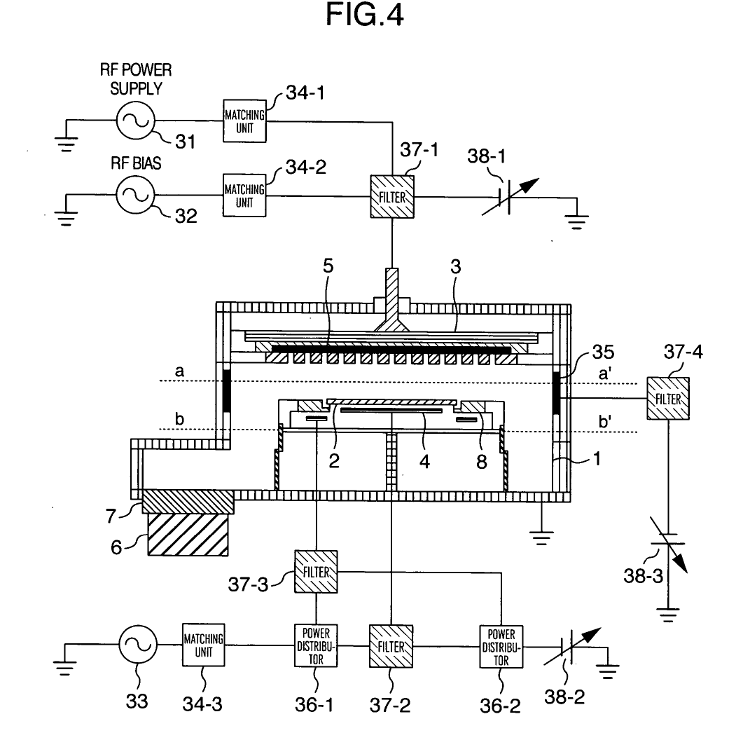

FIG. 4 is a diagram for explaining a plasma processing apparatus according to the second embodiment of the invention. As shown in the diagram, a side wall electrode 35 to apply a bias to the side wall is attached to the side wall corresponding to the plasma forming space of the processing chamber 1. A DC power supply 38-3 is connected to the side wall electrode 35 through a filter unit 37-4.

In the case of the embodiment, it is not always necessary that the frequency of the RF bias electric power which is applied to the antenna electrode 3 and that of the RF bias electric power which is applied to the disposing electrode 4 coincide. Even when the frequencies coincide, it is not always necessary to provide the phase control shown in FIG. 1. It is also possible to use a construction in which the radio frequency bias voltage is not applied to the antenna electrode 3. It is also possible to use a construction in which the RF power supply 31 to generate the plasma is connected to the disposing electrode 4 instead of the antenna electrode 3.

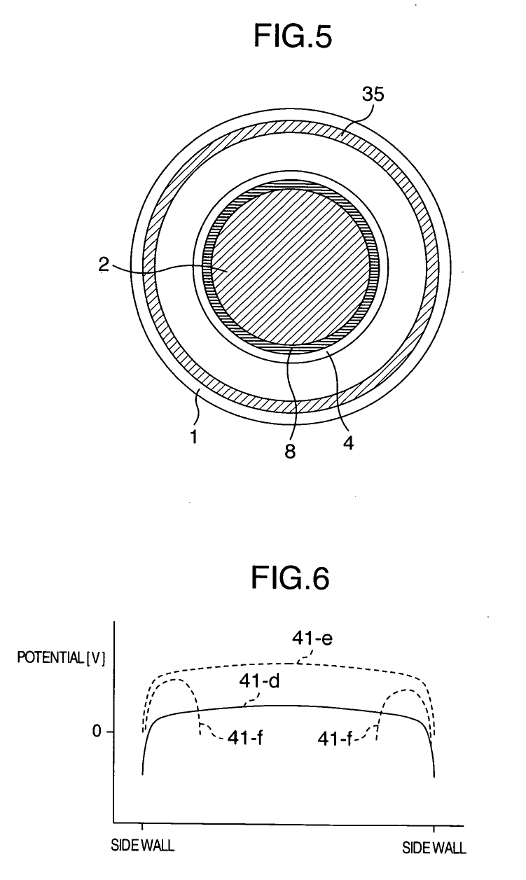

FIG. 5 is a plan view of the processing chamber 1. As shown in the diagram, the side wall electrode 35 has a structure in which it is continuous in the circumferential direction. It is assumed that the side wall electrode 35 is made of, for example, aluminum or stainless steel. The surface of the side wall electrode 35 which is come into contact with the plasma is not coated or coated with a film made of alumite, yttria, or the like. The side wall electrode is attached on almost the same plane as the inner wall surface of the processing chamber in which the side wall electrode has been disposed.

FIG. 6 is a diagram for explaining an effect according to the embodiment and shows the space potential distribution between a-a′ and the space potential distribution between b-b′ in FIG. 4.

A broken line 41-e indicates potential distribution in the processing space (a-a′) over the wafer when the DC bias electric power is not applied to the antenna electrode 3, disposing electrode 4, and side wall electrode 35. A broken line 41-f indicates space potential distribution in the processing space (b-b′) under the wafer surface. On the other hand, a solid line 41-d indicates potential distribution in the processing space (a-a′) over the wafer when the electric potential of each of the antenna electrode 3, disposing electrode 4, and side wall electrode 35 is reduced to a value lower than a grounding potential.

As will be understood from a comparison between the solid line 41-d and the broken line 41-e, by controlling the electric potential of each of the antenna electrode 3, disposing electrode 4, and side wall electrode 35, the space potential in the processing space over the wafer can be reduced. That is, although the electric field distribution almost above the processing object does not change so much, the potential distribution (absolute value) can be largely changed.

On the other hand, the space potential distribution in the space under (b-b′) the wafer surface is almost similar to that shown by the broken line 41-f. Therefore, the electric potential in the processing space over the wafer surface can be reduced to a value lower than that in the processing space under the wafer surface. The foreign particles which have been charged to the negative electric potential can be conveyed from the processing space just above the wafer into the space on the evacuating side under the wafer surface. Thus, the foreign particles can be removed from the space over the processing object.

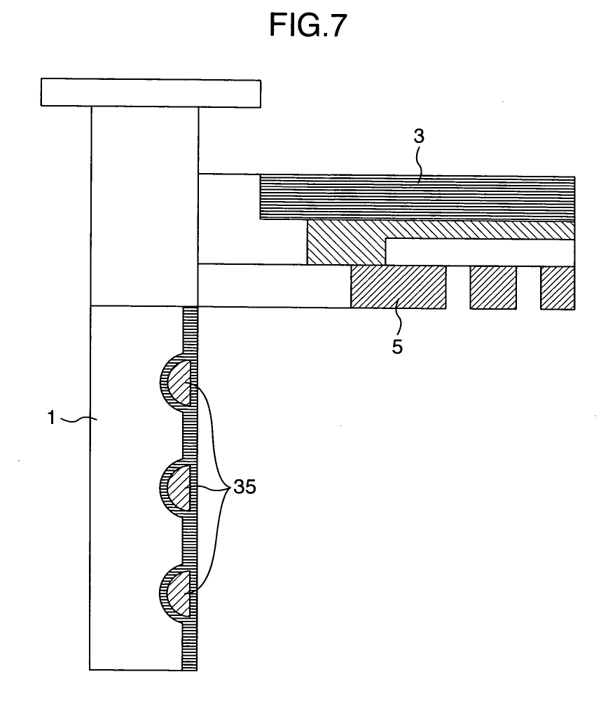

FIG. 7 is a diagram for explaining the third embodiment of the invention. In this embodiment, a plurality of conductors are arranged in the circumferential direction along the side wall of the processing chamber and used as side wall electrodes 35. The side wall electrodes 35 are embedded into the side wall of the processing chamber and the surfaces of the side wall electrodes 35 are set to almost the same plane as the side wall of the processing chamber. This is because if there is a projecting matter or the like in the processing chamber, the projecting matter itself is consumed and becomes a factor of occurrence of foreign particles. Since a construction other than the side wall electrodes is similar to that in FIG. 4, its explanation is omitted.

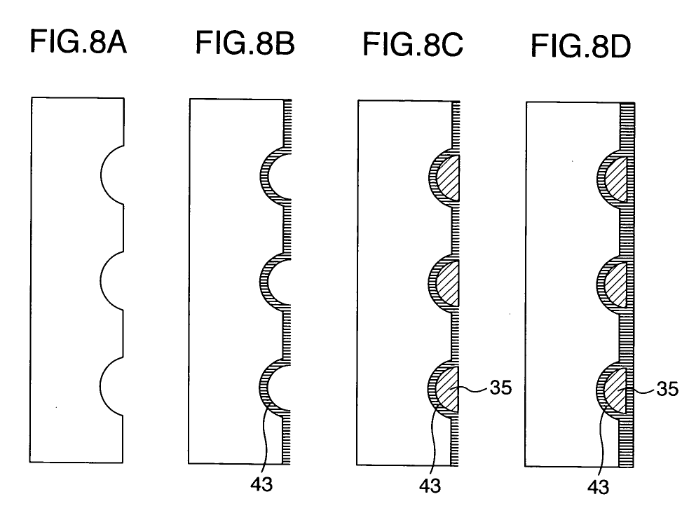

FIGS. 8A to 8D are diagrams for explaining a method of embedding the side wall electrodes 35 into a side wall of the processing chamber. First, as shown in FIG. 8A, grooves each of which has a shape similar to that of the side wall electrode and is larger than the side wall electrode are formed in a base material constructing the side wall. As a side wall base material, for example, aluminum, stainless steel, or the like is used. Subsequently, as shown in FIG. 8B, an insulating film 43 made of yttria, alumina, or the like is formed onto the whole surface of the side wall by a spraying method or the like. As shown in FIG. 8C, a size of each groove which is formed on the base material side is set in such a manner that a shape in the groove after the insulating film 43 is formed in the groove is almost the same as that of the side wall electrode and, when the side wall electrodes are attached into the grooves, the insulating film of the side wall and the side wall electrodes are set to almost the same plane. As a material of the side wall electrode, for example, aluminum, stainless steel, or the like can be used. Subsequently, as shown in FIG. 8D, in the state where the side wall electrodes are set into the grooves formed on the side wall, an insulating film made of yttria, alumite, or the like is formed by a spraying method or the like and the side wall electrodes are embedded into the side wall.

Such an embedding step can be also used, for example, to embed the cylindrical side wall electrode as shown in FIG. 5. In the case of using a structure in which the side wall electrode is subjected to the plasma, it is proper to fix the side wall electrode to the side wall by using screws or the like in the state of FIG. 8C.

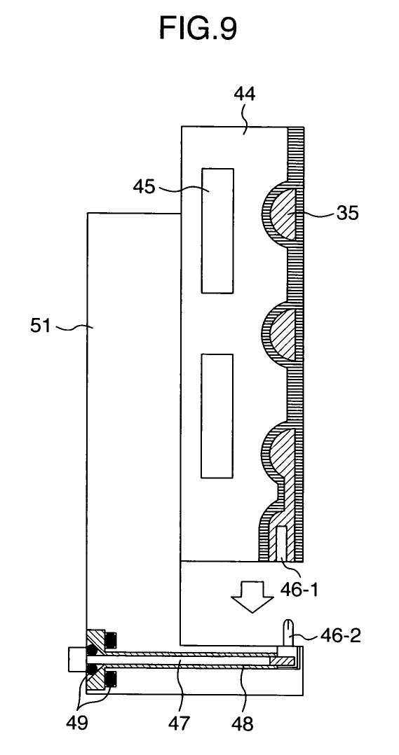

FIG. 9 is a diagram for explaining a method of supplying an electric power to the side wall electrodes 35. In the example of the Figure, the side wall electrode portions are detachably constructed as swapping parts. The side wall electrodes 35 are arranged in an inner casing 44. The inner casing 44 can be removed from a vacuum chamber 51. Channels 45 to flow a coolant for controlling a temperature of the side wall of the processing chamber are provided in the inner case 44.

A joint 46-1 electrically connected to the side wall electrodes 35 is provided in a lower portion of the inner casing 44. A joint 46-2 which is connected to the joint 46-1 is attached to the vacuum chamber 51. Thus, when the inner casing 44 is disposed in a predetermined position of the vacuum chamber 51, the joints 46-1 and 46-2 are connected.

The joint 46-2 on the vacuum chamber side is fixed with a screw 47 from the outside of the vacuum chamber 51. As a screw 47, a conductive material such as aluminum, stainless steel, or the like is used in order to allow the screw 47 to have a function as a wire for supplying an electric power to the side wall electrodes. Sleeves 48 are inserted between the screw 47 and the vacuum chamber 51 and between the joint 46-2 and the vacuum chamber 51 so that they are insulated. As a sleeve 48, an insulating material such as alumina, quartz, PEEK, VESPEL® (trade name), or the like is used. To hold the vacuum state in the processing chamber, O-rings 49 are provided between the sleeve and the vacuum chamber and between the screw and the sleeve, thereby sealing them.

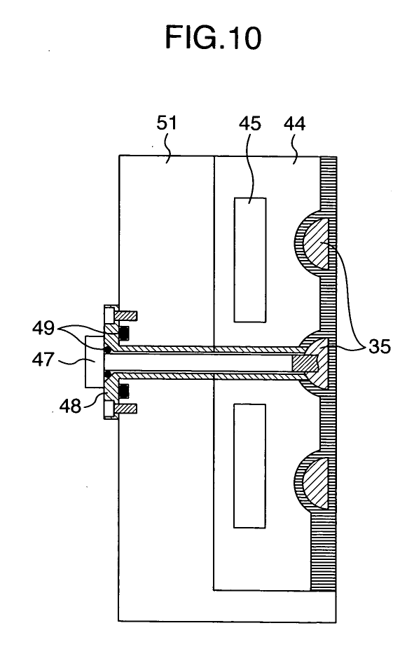

FIG. 10 is a diagram for explaining another method of supplying an electric power to the side wall electrodes. In the example of the diagram, a through-hole penetrating the vacuum chamber and a hole which starts from the vacuum chamber side formed in the inner casing and reaches the side wall electrode 35 are formed, and the screw 47 which penetrates the through-hole and reaches the side wall electrode 35 is attached. The screw 47 functions as a conductor for supplying the electric power to the side wall electrode 35. The sleeve 48 is attached to the periphery of the screw 47 so that the screw 47 and the vacuum chamber 51 are not electrically made conductive and the screw 47 and the inner casing 44 are not electrically made conductive. The O-rings 49 are provided between the screw 47 and the sleeve 48 and between the sleeve 48 and the vacuum chamber 51 and they are sealed so that the vacuum state of the processing chamber can be held.

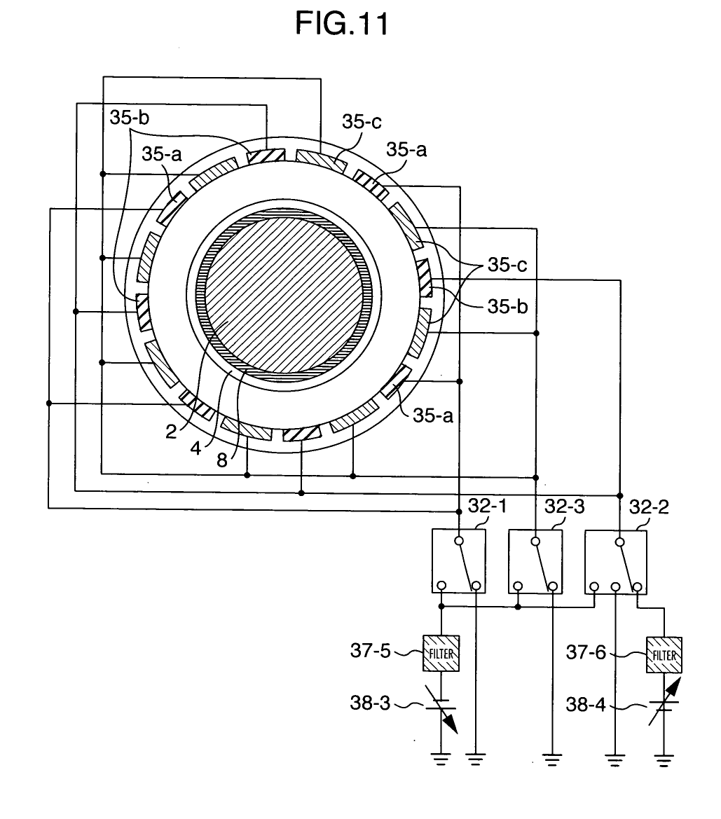

FIG. 11 is a diagram for explaining the fourth embodiment of the invention and is a plan view of the plasma processing apparatus. As shown in the diagram, the side wall electrode 35 is arranged on the inner periphery of the processing chamber 1. The side wall electrode 35 is divided into a plurality of electrodes in the circumferential direction. The side wall electrode 35 is classified into three kinds of electrodes 35-a, 35-b, and 35-c in dependence on a difference among electric wiring systems which are connected to the DC power supplies. The side wall electrodes 35-a, 35-b, and 35-c are sequentially arranged in the circumferential direction.

The DC power supply 38-3 is connected to the side wall electrodes 35-a through a filter unit 37-5. Further, by providing a switch between the side wall electrodes 35-a and the filter unit 37-5, the side wall electrode can be connected to the ground. A DC power supply 38-4 is connected to the side wall electrodes 35-b through a switch 32-2 and a filter unit 37-6. By switching the switch 32-2, it is possible to select a desired one of a mode of applying an electric power which is outputted from the DC power supply 38-3 to the side wall electrodes 35-b, a mode of applying an electric power which is outputted from the DC power supply 38-4 to the side wall electrodes 35-b, and a mode of setting the side wall electrodes 35-b to the grounding potential. The DC power supply 38-3 is connected to the side wall electrodes 35-c through a switch 32-3 and the filter unit 37-5. By switching the switch 32-3, the side wall electrodes 35-c can be set to the grounding potential. For example, capacitors or the like are used for the filter units 37-5 and 37-6, thereby preventing that the radio frequency electric power or the radio frequency bias electric power for generating the plasma flows into the DC power supply through the side wall electrodes.

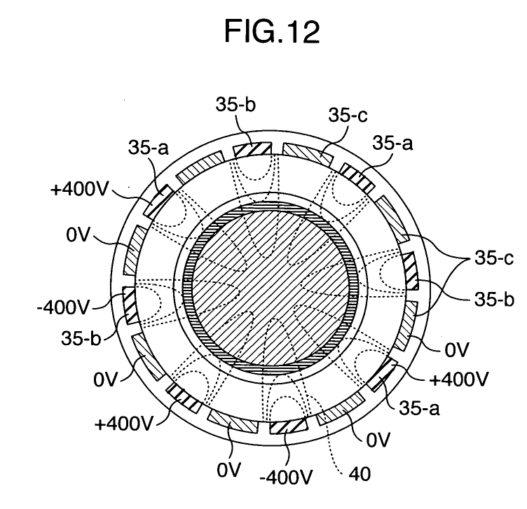

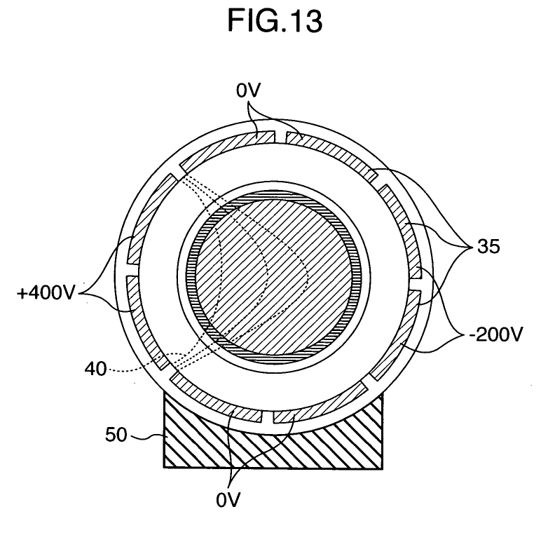

FIG. 12 is a diagram for explaining an effect according to the embodiment. FIG. 12 shows an outline of an equipotential surface 40 over the processing object in the case where a voltage of +400V is applied to the side wall electrodes 35-a, a voltage of −400V is applied to the side wall electrodes 35-b, and the side wall electrodes 35-c are held to the grounding potential. The above electric potential is applied to each electrode before the start of the plasma discharging or after the end of the plasma discharging.

By applying the positive and negative biases to the side wall electrodes in the circumferential direction as mentioned above, the electric field which is almost parallel with the processing object can be formed over the processing object. Thus, just before the start of the discharging or just after the end of the discharging, the foreign particles can be drawn in the direction of the side wall electrodes, thereby making it possible to prevent the foreign particles from being deposited onto the processing object. Even when the discharging is not executed (for example, upon transport), a part of the foreign particles are charged and are floating in the processing chamber 1. Therefore, if the electric field as shown in FIG. 12 is formed, it is also effective upon transport of the processing object.

FIG. 13 is a diagram for explaining the fifth embodiment of the invention. In the example (fourth embodiment) shown in FIG. 12 as mentioned above, the order of the electric potentials which are applied to the side wall electrodes is almost rotation-symmetrical. In this case, structures of the equipotential surfaces are also almost rotation-symmetrical. In such a case, a place where the electric field in the direction which is almost parallel with the processing object is equal to 0 occurs near the center of the processing object. However, if bias applying distribution is set to be non-rotation-symmetrical, an electric field can be also generated near the space just above the center of the processing object.

In the fifth embodiment, as shown in FIG. 13, the side wall electrode 35 is divided into eight electrodes in the circumferential direction. The distribution in the circumferential direction of the bias electric powers which are applied to the side wall electrodes is set to be non-rotation-symmetrical. That is, an electric potential of +400V is applied to the two side wall electrodes locating on the left side of a conveying port 50 for conveying the processing object into or out of the processing chamber, an electric potential of −200V is applied to the two side wall electrodes locating on the right side of the conveying port 50, and the other four side wall electrodes are connected to the grounding potential.

In this case, it will be understood that the electric field is also formed in a space over the place near the center of the processing object disposed to the disposing electrode 4. This electric field is formed in the direction which is almost perpendicular to the direction of a conveying path of the processing object. Therefore, the foreign particles are conveyed in the direction which is almost perpendicular to the direction of the conveying path of the processing object. Thus, the number of foreign matters which are deposited onto the processing object during the transport of the processing object can be reduced.

When the side wall electrode is divided into a plurality of electrodes as shown in FIGS. 11 and 13, if all of the electric potential of the side wall electrodes, the electric potential of the antenna electrode, and the electric potential of the disposing electrode are reduced, the electric potential of the space over the processing object can be reduced as shown in the second embodiment (FIG. 4). Thus, the foreign particles can be removed from the space over the processing object during the discharging. That is, if the side wall electrode is divided into a plurality of electrodes in the circumferential direction and, for example, the different bias electric powers can be applied to the divided side wall electrodes, the foreign particles can be removed at all timing before, during, and after the discharging.

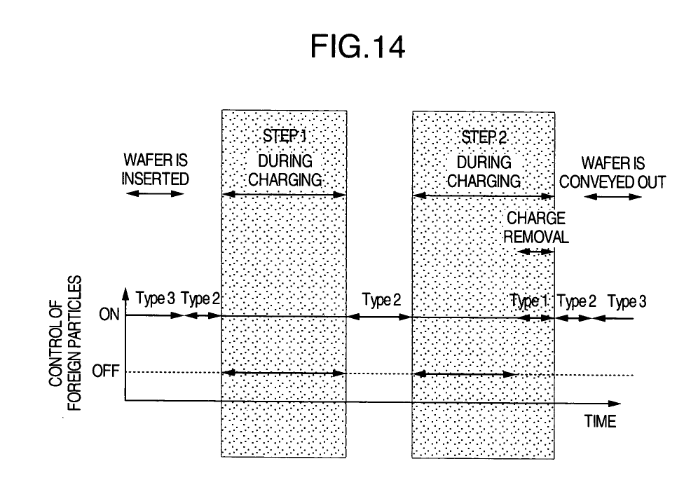

FIG. 14 is a diagram for explaining a method of controlling the electric potential distribution in the processing chamber. Explanation will be made here as an example with respect to the case of executing an etching treatment by using a plasma processing apparatus. It is assumed that the plasma processing apparatus which is used here has: the function of reducing the electric potential of the whole processing space over the processing object shown in the first to third embodiments (Type 1); the function of generating the almost-rotation symmetrical electric field shown in the fourth embodiment (Type 2); and the function of generating the non-rotation symmetrical electric field shown in the fifth embodiment (Type 3). It is also assumed that the etching treatment is constructed by two processing steps STEP1 and STEP2.

First, when the processing object is conveyed into the processing chamber, the electric field of Type 3 which can convey the foreign matters in the direction which is almost perpendicular to the conveying path of the processing object is formed so that no foreign particles are deposited onto the processing object. Just before the start of the discharging of STEP1, the electric field of Type 2 is formed. The reason why the electric potential is switched from Type 3 to Type 2 as mentioned above is as follows. That is, while the foreign particles traverse, for example, from the right edge to the left edge of the processing object in Type 3, in the case of using the potential distribution of Type 2, the foreign particles floating over the processing object move in almost the radial direction, so that a locus just above the wafer is shortened and a probability that the foreign particles are deposited onto the processing object is smaller than that in the case of Type 3.

Subsequently, the electric field of Type 2 is formed for a period of time from the timing just after the end of the discharging of STEP1 to the timing just before the discharging of STEP2.

After predetermined processes are executed to the processing object in STEP2, a charge removing process to cancel the electrostatic chuck to fix the processing object to the disposing electrode is executed. The charge removing process is executed while changing a DC electric power of the electrostatic chuck. The electric field of Type 1 is formed during the charge removal. Since the DC bias electric power applied to the disposing electrode is changed during the charge removal, the DC bias electric power which is applied to the antenna electrode or the side wall electrodes may be also changed in an interlocking relational manner with the change in the electric power of the electrostatic suction. Since the process such as an etching or the like is not executed during the charge removal, for example, by increasing a flow rate of a processing gas which is supplied from the shower plate, two forces of the potential control and the gas flow can be used. In this case, the foreign particles can be more effectively removed from the space over the processing object.

After completion of the charge removal, the electric field of Type 2 is formed. When the processing object is conveyed out of the processing chamber, the electric field of Type 3 is formed. Although the potential distribution control is not made for a period of time during which the predetermined process is executed to the processing object in STEP1 and STEP2 in FIG. 14, the foreign matter control of Type 1 may be also made while the process is being executed. Although the invention has been described on the assumption that it is applied to the plasma processing apparatus, the invention can be also applied to other semiconductor manufacturing apparatuses which do not use the plasma or the removal of the foreign particles of a semiconductor inspecting apparatus.

As described above, according to the embodiments of the invention, the electric potential of the processing space over the height position where the processing object has been disposed can be set to be lower than that of the space under the height position where the processing object has been disposed. A plurality of side wall electrodes for applying the bias to the side wall of the processing chamber are provided in the circumferential direction and the positive or negative bias is applied to those electrodes, so that the electric field in the direction which is almost parallel with the processing object can be formed in the space over the processing object. Therefore, for example, by reducing the electric potential of the processing space over the processing object during the discharging, the foreign particles in the space over the processing object can be removed. Further, the electric field which is almost parallel with the processing object is formed into the space over the processing object is formed before or after the discharging, so that the foreign particles can be removed from the space over the processing object. Thus, the yield of the semiconductor devices can be improved.

It should be further understood by those skilled in the art that although the foregoing description has been made on embodiments of the invention, the invention is not limited thereto and various changes and modifications may be made without departing from the spirit of the invention and the scope of the appended claims.

1. A plasma processing apparatus comprising:
a processing chamber;
a processing gas supplying unit which supplies a processing gas into said processing chamber;
an antenna electrode which supplies a radio frequency electric power into the processing chamber and generating a plasma;
a vacuum evacuating unit which evacuates the inside of the processing chamber;
a disposing electrode which disposes an object to be processed into the processing chamber and holding the object therein; and
a DC power supply which supplies a negative electric potential to said antenna electrode.

2. A plasma processing apparatus comprising:
a processing chamber;
a processing gas supplying unit which supplies a processing gas into said processing chamber;
an antenna electrode which supplies a radio frequency electric power into the processing chamber and generating a plasma;
a vacuum evacuating unit which evacuates the inside of the processing chamber;
a disposing electrode which disposes an object to be processed into the processing chamber and holding the object therein;
a radio frequency power supply for an antenna device, which supplies a radio frequency bias voltage to said antenna electrode;
a radio frequency power supply for a disposing electrode bias, which supplies a radio frequency bias voltage to said disposing electrode;
a phase controller which adjusts a phase difference between said radio frequency power supply for the antenna device and said radio frequency power supply for the disposing electrode bias; and
a DC power supply which supplies a negative electric potential to said antenna electrode.

3. A plasma processing apparatus comprising:
a processing chamber;
a processing gas supplying unit which supplies a processing gas into said processing chamber;
an antenna electrode which supplies a radio frequency electric power into the processing chamber and generating a plasma;
a vacuum evacuating unit which evacuates the inside of the processing chamber;
a disposing electrode which disposes an object to be processed into the processing chamber and holding the object therein;
a radio frequency power supply for an antenna device, which supplies a radio frequency bias voltage to said antenna electrode;
a radio frequency power supply for a disposing electrode bias, which supplies a radio frequency bias voltage to said disposing electrode;
a side wall electrode formed on a side wall corresponding to a plasma forming space in said processing chamber; and
a DC power supply which supplies a negative electric potential to said side wall electrode.

4. An apparatus according to claim 3, further comprising a DC power supply which supplies a negative electric potential to said antenna electrode.

5. An apparatus according to claim 3, wherein said side wall electrode is constructed by a plurality of electrode members divided in a circumferential direction and different voltages are applied to said electrode members.

6. An apparatus according to claim 3, wherein an inner peripheral side surface of said side wall electrode has the same plane as that of an inner peripheral side surface of said processing chamber.

7. An apparatus according to claim 3, wherein said side wall electrode comprises:
a plurality of grooves formed on an inner peripheral side surface of said processing chamber in a circumferential direction;
insulating films formed on surfaces of said grooves;
conductors formed on said insulating films; and
insulating films with which surfaces of said conductors are coated.

8. An apparatus according to claim 3, wherein a vessel forming said processing chamber has an inner case formed detachably to/from said vessel and a side wall electrode formed in said inner casing, and said side wall electrode is conductive with an outside through holes formed in the vessel forming said processing chamber and in the inner case.
